(19) United States
(12) Patent Application Publication
(10) Pub. No.: US 2011/0050763 A1
(43) Pub. Date: Mar. 3, 2011

(54) IMAGE PROCESSING APPARATUS AND IMAGE PROCESSING METHOD

(75) Inventors: Atsushi Kubota, Shizuoka-ken (JP); Kazuhiko Ohtsu, Shizuoka-ken (JP)

(73) Assignees: KABUSHIKI KAISHA TOSHIBA, Tokyo (JP); TOSHIBA TEC KABUSHIKI KAISHA, Tokyo (JP)

(21) Appl. No.: 12/871,051

(22) Filed: Aug. 30, 2010

Related U.S. Application Data
(60) Provisional application No. 61/238,755, filed on Sep. 1, 2009.

(51) Int. Cl. B41J 29/38; H04N 1/60

(52) U.S. Cl. 347/5; 358/1.9

(57) ABSTRACT

According to one embodiment, an image processing apparatus includes a detecting unit, a determining unit, and a correcting unit. The detecting unit detects an overlapping portion of a first image printed on a first side of a sheet and a second image printed on a second side opposite to the first side. The determining unit determines whether the detected overlapping portion of the first image and the second image is equal to or larger than a predetermined area. The correcting unit corrects, if the overlapping portion is equal to or larger than the predetermined area, the density of one of the first image and the second image.

### CROSS-REFERENCE TO RELATED APPLICATION

This application is based upon and claims the benefit of priority from Provisional Application No. 61/238,755 filed on Sep. 1, 2009, the entire contents of which are incorporated herein by reference.

### FIELD

Embodiments described herein relate generally to a technique for correcting the density of images printed on both sides of a sheet.

### BACKGROUND

In recent years, from the viewpoint of effectively utilizing sheets for resource saving, a user tends to print images on both sides of a sheet (a recording medium) using an ink jet recording apparatus. The ink jet recording apparatus ejects ink from a head to print a desired image on the sheet. The ink adhering to the sheet penetrates from a first side on which the image is printed to a second side opposite to the first side according to characteristics of the sheet, characteristics of the ink, a printing ratio of the printed image, and the like. Thereafter, when the ink jet recording apparatus prints an image on the second side, in some case, the user feels it hard to see the image printed on at least one side.

Therefore, in the ink jet recording apparatus, since it is likely that printing quality falls depending on a type of print data, there is also a method of detecting attributes of the print data and correcting data other than text data (e.g., image data). Further, in the ink jet recording apparatus, there is also a method of detecting, when duplex printing is performed, an overlapping portion of print data and correcting the print data in only the overlapping portion.

However, in order to accurately align printing positions on both sides in correcting the print data only in the overlapping portion of the print data, the ink jet recording apparatus requires a mechanism for accurately conveying a sheet.

### BRIEF DESCRIPTION OF THE DRAWINGS

FIG. 1 is an exemplary sectional view in a lateral direction of an ink jet recording apparatus according to a first embodiment;

FIG. 2 is an exemplary block diagram of the configuration of the ink jet recording apparatus and a host computer according to the first embodiment;

FIG. 3 is an exemplary flowchart for explaining processing for creating recording data according to the first embodiment;

FIG. 4 is an exemplary diagram for explaining density correction for the recording data according to the first embodiment;

FIG. 5 is an exemplary flowchart for explaining processing for creating recording data according to a second embodiment;

FIG. 6 is an exemplary flowchart for explaining processing for creating recording data according to a third embodiment; and

FIG. 7 is an exemplary flowchart for explaining processing for creating recording data according to a fourth embodiment.

### DETAILED DESCRIPTION

In general, according to one embodiment, an image processing apparatus includes a detecting unit, a determining unit, and a correcting unit. The detecting unit detects an overlapping portion of a first image printed on a first side of a sheet and a second image printed on a second side opposite to the first side. The determining unit determines whether the detected overlapping portion of the first image and the second image is equal to or larger than a predetermined area. The correcting unit corrects, if the overlapping portion is equal to or larger than the predetermined area, the density of one of the first image and the second image.

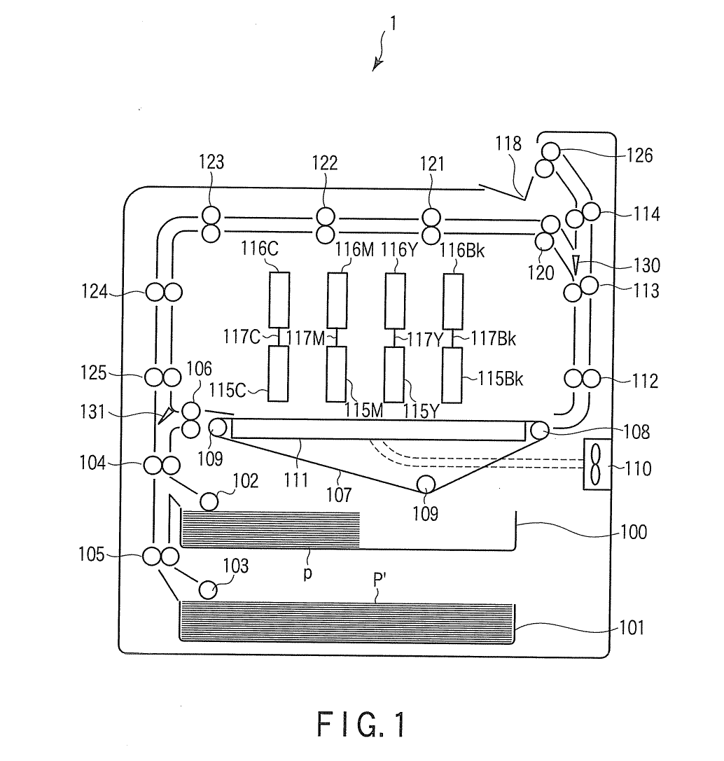

A first embodiment is explained below with reference to the accompanying drawings. FIG. 1 is a sectional view in a lateral direction of an ink jet recording apparatus 1 as an image processing apparatus according to the first embodiment. A first sheet cassette 100 stores a sheet bundle p including plural sheets (recording media). A second sheet cassette 101 stores a sheet bundle p′ including plural sheets of a size different from a size of the sheets stored in the first sheet cassette 100. A first paper feeding roller 102 extracts sheets corresponding to a selected sheet size one by one from the top of the sheet bundle p stored in the first sheet cassette 100 and conveys the sheet to a first conveying roller pair 104 and a registration roller pair 106. Similarly, a second paper feeding roller 103 extracts sheets corresponding to a selected sheet size one by one from the sheet bundle p′ stored in the second sheet cassette 101 and conveys the sheet to a second conveying roller pair 105, the first conveying roller pair 104, and the registration roller pair 106 in this order.

A conveyor belt 107 is endlessly laid over a driving roller 108 and two driven rollers 109. Tension is applied to the conveyor belt 107 by the driving roller 108 and the two driven rollers 109. Holes are opened at predetermined intervals on the surface of the conveyor belt 107. A vacuum chamber 111 coupled to a fan 110 is set on an inner side of the conveyor belt 107 in order to attract the sheet to the conveyor belt 107.

The driving roller 108 drives the conveyor belt 107 to convey the sheet from an upstream side on which the registration roller pair 106 is provided to a downstream side on which a first conveying roller pair 112 is provided. Ink jet recording heads configured to eject inks to the sheet according to print data are arranged in four rows above the conveyor belt 107. An ink jet recording head 115C configured to eject cyan (C) ink, an ink jet recording head 115M configured to eject magenta (M) ink, an ink jet recording head 115Y configured to eject yellow (Y) ink, and an ink jet recording head 115Bk configured to eject black (Bk) ink are arranged in the ink jet recording apparatus 1 in order from the upstream side. The ink jet recording heads 115C, 115M, 115Y, and 115Bk are referred to as image forming units. In each of the ink jet recording heads 115C, 115M, 115Y, and 115Bk, nozzles configured to eject ink droplets are arranged to extend over a width direction of the sheet at predetermined resolution. In other words, the ink jet recording heads 115C, 115M, 115Y, and 115Bk are line-type heads in which not-shown plural nozzles are arrayed on lines. In the ink jet recording heads 115C, 115M, 115Y, and 115Bk, the nozzles are arrayed in a direction orthogonal to a conveying direction of the sheet by the conveyor belt 107. These nozzles are arrayed to be positioned a specified space apart from the sheet located on the conveyor belt 107.

The ink jet recording head 115C and an ink cartridge 116C, the ink jet recording head 115M and an ink cartridge 116M, the ink jet recording head 115Y and an ink cartridge 116Y, and the ink jet recording head 115Bk and an ink cartridge 116Bk are respectively coupled by tubes 117C, 117M, 117Y, and 117Bk. The ink cartridge 116C for cyan (C), the ink cartridge 116M for magenta (M), the ink cartridge 116Y for yellow (Y), and the ink cartridge 116Bk for black (Bk) are respectively filled with inks of the colors.

A space between ends on the conveyor belt 107 side of the respective ink jet recording heads 115C, 115M, 115Y, and 115Bk and the surface of the sheet is kept constant by the vacuum chamber 111. The respective ink jet recording heads 115C, 115M, 115Y, and 115Bk eject the inks of the colors in synchronization of timing when the sheet is conveyed from the registration roller pair 106 to the conveyor belt 107 and an operation for conveying the sheet by the conveyor belt 107. A color image is formed in a desired position on the surface of the sheet by the ink jet recording heads 115C, 115M, 115Y, and 115Bk.

The first conveying roller pair 112, a second conveying roller pair 113, and a third conveying roller pair 114 convey the sheet having an image formed on one side in full-color or the sheet having images formed on both sides in full-color by the ink jet recording heads 115C, 115M, 115Y, and 115Bk to a discharge roller pair 126. The discharge roller pair 126 discharges the sheet subjected to the image formation to a paper discharge tray 118. The paper discharge tray 118 stores sheets one after another in a stacked state.

The ink jet recording apparatus 1 further includes a conveying roller pair 120, a conveying roller pair 121, a conveying roller pair 122, a conveying roller pair 123, a conveying roller pair 124, and a conveying roller pair 125 in order to return the sheet from the downstream side to the upstream side when the ink jet recording apparatus 1 applies the duplex printing to the sheet. A first conveyance guide 131 is provided on the upstream side of the registration roller pair 106. The first conveyance guide 131 is disposed to switch a conveyance route for the sheet. The direction of a guide tip of the first conveyance guide 131 is changed with a not-shown fulcrum as the center. A second conveyance guide 132 is provided on the downstream side of the second conveying roller pair 113. The second conveyance guide 132 is disposed to switch the conveyance route for the sheet. The direction of a guide tip of the second conveyance guide 132 is changed with a not-shown fulcrum as the center.

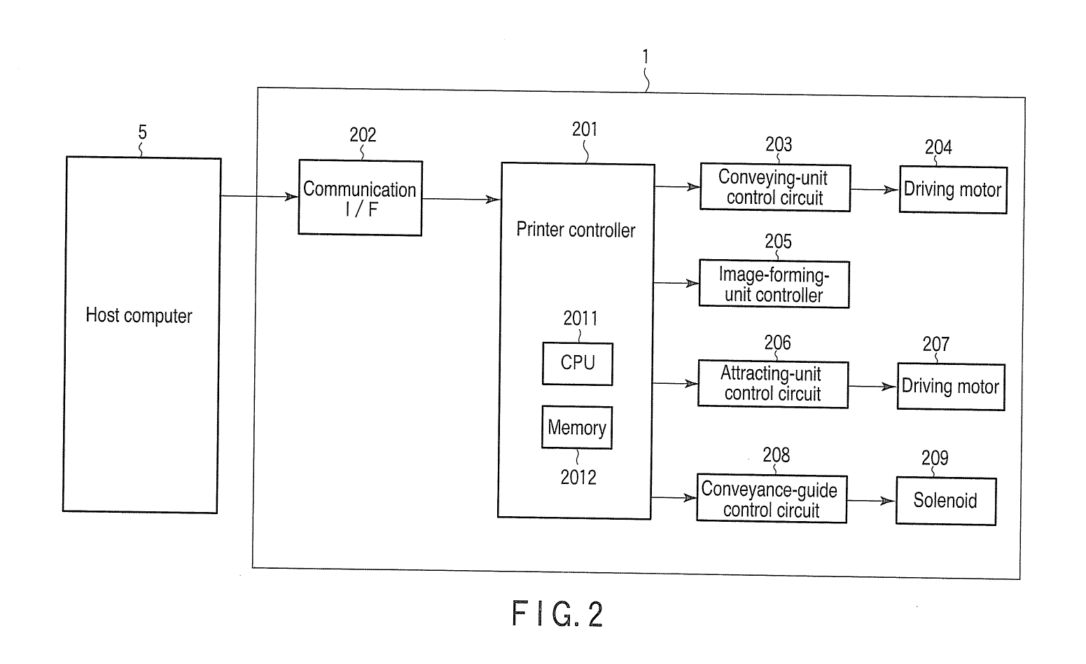

FIG. 2 is a block diagram of a control system for the ink jet recording apparatus 1 and a host computer 5 connected thereto according to the first embodiment. The ink jet recording apparatus 1 includes a printer controller 201, a communication I/F 202, a conveying-unit control circuit 203, a driving motor 204, an image-forming-unit controller 205, an attracting-unit control circuit 206, a driving motor 207, a conveyance-guide control circuit 208, and a solenoid 209.

The printer controller 201 is a microcomputer including a CPU 2011 as a processor and a memory 2012. The CPU 2011 executes various kinds of arithmetic processing according to computer programs stored in the memory 2012. The CPU 2011 outputs control signals to the respective units. The CPU 2011 communicates with, via the communication I/F 202, the host computer 5 connected to the ink jet recording apparatus 1. The CPU 2011 receives, from the host computer 5, recording information and various kinds of attribute information concerning the recording information together with a print request input by a user. The recording information includes image data to be printed on a sheet and instruction information concerning whether printing is duplex printing or simplex printing. The attribute information is, for example, information concerning a type of an object of the image data, position information of the object of the image data, and color information of the object of the image data. The CPU 2011 converts the image data into recording data suitable for printing.

The conveying-unit control circuit 203 controls the driving motor 204. The driving motor 204 drives the conveying roller pairs and the registration roller pair configured to convey the sheet during image formation. The image-forming-unit controller 205 controls image forming operations by the ink jet recording heads 115C, 115M, 115Y, and 115Bk on the basis of the recording data. The attracting-unit control circuit 206 controls the driving motor 207. The driving motor 207 drives the fan 110. The conveyance-guide control circuit 208 controls the solenoid 209. The solenoid 209 drives the first conveyance guide 131 and the second conveyance guide 132.

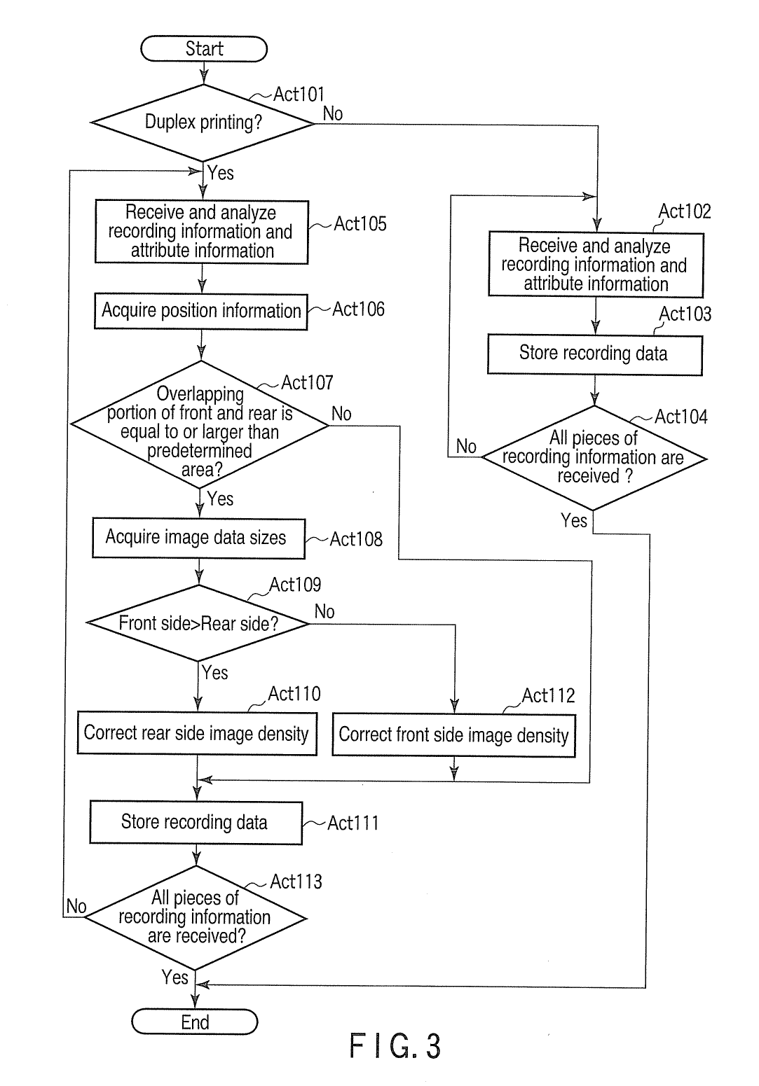

Processing for creating recording data in the ink jet recording apparatus 1 is explained below. FIG. 3 is a flowchart for explaining processing for creating recording data according to the first embodiment. The first embodiment is an example in which print density is corrected according to position information of image data printed on the front side of a sheet and image data printed on the rear side of the sheet. First, the CPU 2011 determines whether an instruction for the duplex printing is included in recording information requested to be printed (Act 101).

If the duplex printing is not instructed (i.e., when the simplex printing is instructed) (No in Act 101), the CPU 2011 receives and analyzes recording information and attribute information concerning the simplex printing input in the host computer 5 (Act 102). The CPU 2011 converts image data of one side acquired from the recording information into recording data and temporarily stores the recording data in the memory 2012 (Act 103). The CPU 2011 determines whether all pieces of recording information in one print request are analyzed (Act 104). If all the pieces of recording information are analyzed (Yes in Act 104), the CPU 2011 ends the conversion into recording data. If not all the pieces of recording information are analyzed (No in Act 104), the CPU 2011 returns to Act 102 and continues the processing.

If the duplex printing is instructed (Yes in Act 101), the CPU 2011 receives and analyzes recording information and attribute information concerning the duplex printing input in the host computer 5 (Act 105). The CPU 2011 acquires position information of image data of a front side (a first side) and a rear side (a second side) from the attribute information of the respective sides (Act 106). Act 106 is a detecting act for detecting an overlapping portion of the front side and the rear side. The CPU 2011 determines whether, when images are formed on the front side and the rear side of a sheet in the ink jet recording apparatus 1, an overlapping portion of the front and the rear is equal to or larger than a predetermined area (Act 107). Act 107 is a determining act for determining whether the overlapping portion is equal to or larger than the predetermined area. If the overlapping portion is equal to or larger than the predetermined area (Yes in Act 107), the CPU 2011 acquires image data sizes of the overlapping portion of the front side and the rear side from the attribute information (Act 108). The CPU 2011 compares, concerning the image data sizes in the overlapping portion, the image data sizes of the rear side and the image data size of the front side and determines whether the former is smaller than the latter (Act 109). Act 109 is a front and rear comparing act. If the image data size of the rear side is smaller than the image data size of the front side (Yes in Act 109), the CPU 2011 corrects (reduces) the density of the image data of the rear side (Act 110). After correcting the image data of the rear side, the CPU 2011 converts the image data into recording data and temporarily stores the recording data in the memory 2012 (Act 111).

If the image data of the front side is smaller than the image data of the rear side (No in Act 109), the CPU 2011 corrects (reduces) the density of the image data of the front side (Act 112). Acts 110 and 112 are density correcting acts for correcting density. After correcting the image data of the front side, the CPU 2011 converts the image data into recording data and temporarily stores the recording data in the memory 2012 (Act 111). If the overlapping portion is not equal to or larger than the predetermined area (No in Act 107), the CPU 2011 converts the image data of both the sides into recording data without correcting the image data and temporarily stores the recording data in the memory 2012 (Act 111).

Thereafter, the CPU 2011 determines whether all pieces of recording information in one print request are analyzed (Act 113). If all the pieces of recording information are analyzed (Yes in Act 113), the CPU 2011 ends the conversion into recording data. If not all the pieces of recording information are analyzed (No in Act 113), the CPU 2011 returns to Act 105 and continues the processing. Thereafter, the CPU 2011 outputs the recording data stored in the memory 2012 to the image-forming-unit controller 205. The image-forming-unit controller 205 controls the ink jet recording heads 115C, 115M, 115Y, and 115Bk to form images on both the sides or the one side of the sheet on the basis of the recording data. The CPU 2011 temporarily stores, every time image data is converted into recording data in Act 111, the recording data in the memory 2012 and outputs all recording data in one print request to the image-forming-unit controller 205 at a time. However, the CPU 2011 may output, every time image data is converted into recording data, the recording data to the image-forming-unit controller 205.

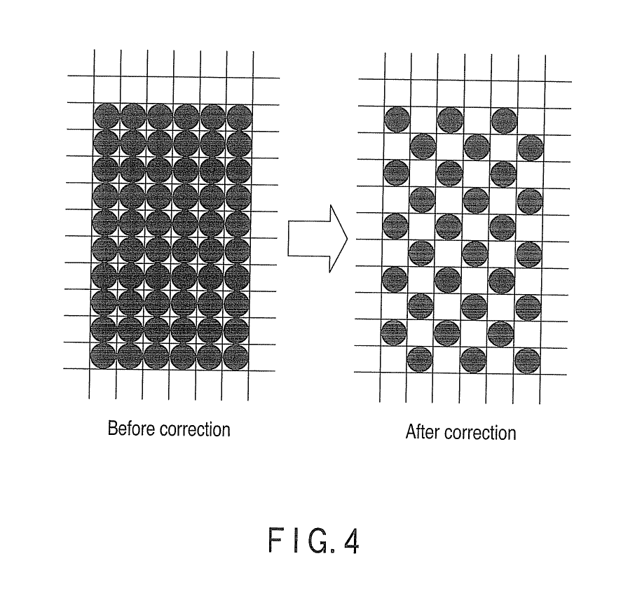

Density correction for image data by the CPU 2011 is explained below. The CPU 2011 performs thinning-out processing for pixels in order to reduce the density of image data. FIG. 4 is a diagram for explaining density correction for correcting the density of image data at a thinning-out ratio of 50%. In the image data, pixels in a portion where an image is formed by the ink jet recording apparatus 1 are corrected to pixels on which an image is not formed. The CPU 2011 can change the thinning-out ratio according to, for example, an area of an overlapping portion of the front and the rear. When the density correction for image data is performed, the CPU 2011 preferentially subjects black pixels to thinning-out processing. The image-forming-unit controller 205 controls ink amounts ejected from the ink jet recording heads 115C, 115M, 115Y, and 115Bk to be reduced according to the thinning-out ratio. If the ink jet recording heads 115C, 115M, 115Y, and 115Bk are a multi-drop type, the image-forming-unit controller 205 may control the number of ink droplets to be reduced according to the thinning-out ratio. It is effective for the image-forming-unit controller 205 to perform control such that an image of image data having a smaller thinning-out ratio is formed on a sheet earlier.

In Acts 110 and 111, the CPU 2011 corrects the density of the image data of the side having the smaller image data size to be reduced. However, the CPU 2011 may correct the density of the image data of the side having the larger image data size to be reduced. In this case, the ink jet recording apparatus 1 can save inks necessary for forming images.

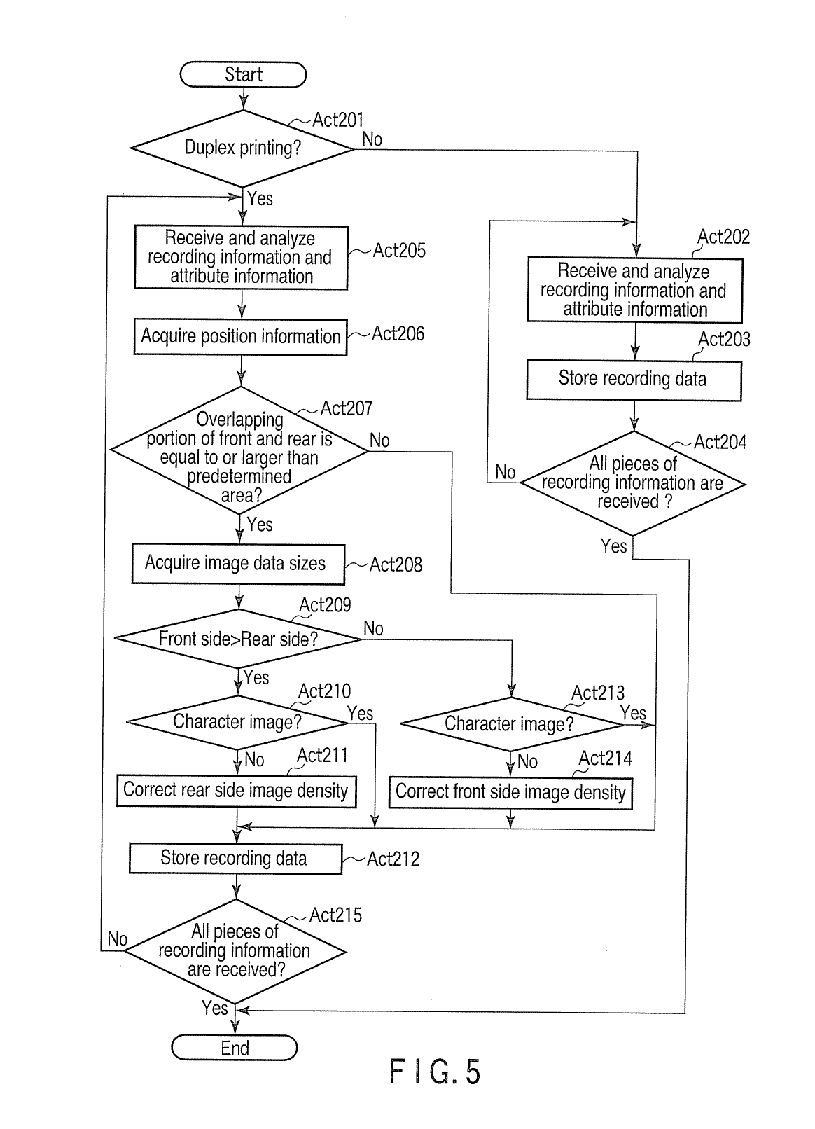

FIG. 5 is a flowchart for explaining processing for creating recording data according to a second embodiment. The second embodiment is an example in which print density is corrected according to position information and types of image data printed on the front side of a sheet and image data printed on the rear side of the sheet. First, the CPU 2011 determines whether an instruction for the duplex printing is included in recording information requested to be printed (Act 201). If the duplex printing is not instructed (No in Act 201), the CPU 2011 receives and analyzes recording information and attribute information concerning the simplex printing input in the host computer 5 (Act 202). The CPU 2011 converts image data of one side acquired from the recording information into recording data and temporarily stores the recording data in the memory 2012 (Act 203). The CPU 2011 determines whether all pieces of recording information in one print request are analyzed (Act 204). If all the pieces of recording information are analyzed (Yes in Act 204), the CPU 2011 ends the conversion into recording data. If not all the pieces of recording information are analyzed (No in Act 204), the CPU 2011 returns to Act 202 and continues the processing.

If the duplex printing is instructed (Yes in Act 201), the CPU 2011 receives and analyzes recording information and attribute information concerning the duplex printing input in the host computer 5 (Act 205). The CPU 2011 acquires position information of image data of the front side and the rear side of a sheet from the attribute information of the respective sides (Act 206). The CPU 2011 determines whether, when images are formed on the front side and the rear side of the sheet in the ink jet recording apparatus 1, an overlapping portion of the front and the rear is equal to or larger than a predetermined area (Act 207). If the overlapping portion is equal to or larger than the predetermined area (Yes in Act 207), the CPU 2011 acquires image data sizes of the overlapping portion of the front side and the rear side from the attribute information (Act 208). The CPU 2011 compares, concerning the image data sizes in the overlapping portion, the image data size of the rear side and the image data size of the front side and determines whether the former is smaller than the latter (Act 209). Act 209 is a front and rear comparing act.

If the image data size of the rear side is smaller than the image data size of the front side (Yes in Act 209), the CPU 2011 determines whether the image data of the rear side is character (text) data (Act 210). If the image data of the rear side is not character data (if the image data of the rear side is, for example, photograph data) (No in Act 210), the CPU 2011 corrects (reduces) the density of the image data of the rear side (Act 211). After correcting the image data of the rear side, the CPU 2011 converts the image data into recording data and temporarily stores the recording data in the memory 2012 (Act 212). If the image data of the rear side is character data (Yes in Act 210), the CPU 2011 converts the image data of both the sides into recording data without correcting the image data and temporarily stores the recording data in the memory 2012 (Act 212).

If the image data of the front side is character data (Yes in Act 210), the CPU 2011 converts the image data of both the sides into recording data without correcting the image data and temporarily stores the recording data in the memory 2012 (Act 212). If the image data of the front side is smaller than the image data of the rear side (No in Act 209), the CPU 2011 determines whether the image data of the front side is character data (Act 213). Acts 210 and 213 are character image comparing acts. If the image data of the front side is not character data (No in Act 213), the CPU 2011 corrects (reduces) the density of the image data of the front side (Act 214). After correcting the image data of the front side, the CPU 2011 converts the image data into recording data and temporarily stores the recording data in the memory 2012 (Act 212). If the overlapping portion is not equal to or larger than the predetermined area (No in Act 207), the CPU 2011 converts the image data of both the sides into recording data without correcting the image data and temporarily stores the recording data in the memory 2012 (Act 212).

Thereafter, the CPU 2011 determines whether all pieces of recording information in one print request are analyzed (Act 215). If all the pieces of recording information are analyzed (Yes in Act 215), the CPU 2011 ends the conversion into recording data. If not all the pieces of recording information are analyzed (No in Act 215), the CPU 2011 returns to Act 205 and continues the processing. Thereafter, the CPU 2011 outputs the recording data stored in the memory 2012 to the image-forming-unit controller 205 in the same manner as in the first embodiment.

If the image data is not character data in Acts 210 and 213, the CPU 2011 does not correct the image data. However, the CPU 2011 may further determine, according to a type of character data, whether density correction is performed. For example, it is also possible that, if the character data is a thin-line character or a low-density character having density lower than predetermined density, the CPU 2011 does not perform density correction in order to give priority to identity of the character and, if the character data is a thick-line character or a high-density character, the CPU 2011 performs density correction because it is likely that image deterioration occurs. In Acts 211 and 214, the CPU 2011 corrects the density of the image data of the side having the smaller image data size in the overlapping portion to be reduced. However, the CPU 2011 may correct the density of the image data of the side having the larger image data size to be reduced. In this case, the ink jet recording apparatus 1 can save inks necessary for forming images.

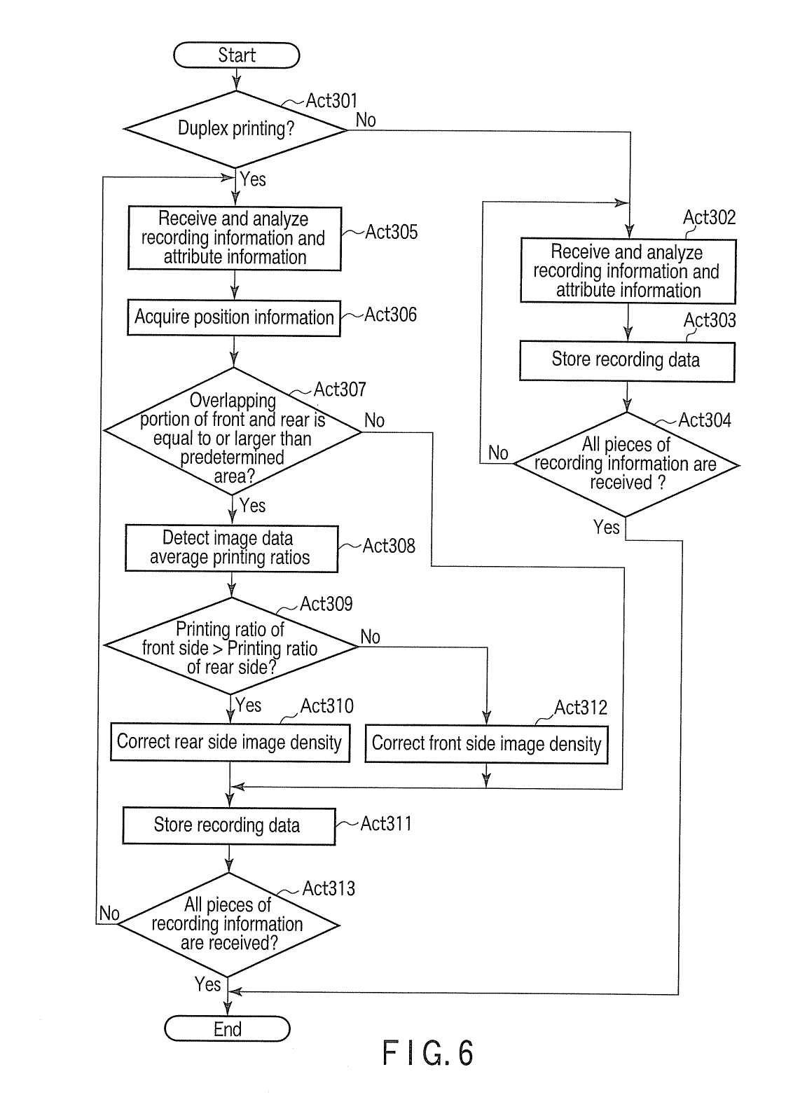

FIG. 6 is a flowchart for explaining processing for creating recording data according to a third embodiment. The third embodiment is an example in which print density is corrected according to position information and an average printing ratio of image data printed on the front side of a sheet and image data printed on the rear side of the sheet. First, the CPU 2011 determines whether an instruction for the duplex printing is included in recording information requested to be printed (Act 301). If the duplex printing is not instructed (No in Act 301), the CPU 2011 receives and analyzes recording information and attribute information concerning the simplex printing input in the host computer 5 (Act 302). The CPU 2011 converts image data of one side acquired from the recording information into recording data and temporarily stores the recording data in the memory 2012 (Act 303). The CPU 2011 determines whether all pieces of recording information in one print request are analyzed (Act 304). If all the pieces of recording information are analyzed (Yes in Act 304), the CPU 2011 ends the conversion into recording data. If not all the pieces of recording information are analyzed (No in Act 304), the CPU 2011 returns to Act 302 and continues the processing.

If the duplex printing is instructed (Yes in Act 301), the CPU 2011 receives and analyzes recording information and attribute information concerning the duplex printing input in the host computer 5 (Act 305). The CPU 2011 acquires position information of image data of the front side and the rear side of a sheet from the attribute information of the respective sides (Act 306). The CPU 2011 determines whether, when images are formed on the front side and the rear side of the sheet in the ink jet recording apparatus 1, an overlapping portion of the front and the rear is equal to or larger than a predetermined area (Act 307). If the overlapping portion is equal to or larger than the predetermined area (Yes in Act 307), the CPU 2011 detects average printing ratios of the overlapping portion of the front side and the rear side from the attribute information (Act 308). The CPU 2011 compares, concerning the average printing ratios in the overlapping portion, the average printing ratios of the rear side and the average printing ratio of the front side and determines whether the former is smaller than the latter (Act 309). Act 309 is a printing ratio comparing act.

If the average printing ratio of the rear side in the overlapping portion is smaller than the average printing ratio of the front side in the overlapping portion (Yes in Act 309), the CPU 2011 corrects (reduces) the density of the image data of the rear side (Act 310). After correcting the image data of the rear side, the CPU 2011 converts the image data into recording data and temporarily stores the recording data in the memory 2012 (Act 311). If the average printing ratio of the front side in the overlapping portion is smaller than the average printing ratio of the rear side in the overlapping portion (No in Act 309), the CPU 2011 corrects (reduces) the density of the image data of the front side (Act 312). After correcting the image data of the front side, the CPU 2011 converts the image data into recording data and temporarily stores the recording data in the memory 2012 (Act 311). If the overlapping portion is not equal to or larger than the predetermined area (No in Act 307), the CPU 2011 converts the image data of both the sides into recording data without correcting the image data and temporarily stores the recording data in the memory 2012 (Act 311).

Thereafter, the CPU 2011 determines whether all pieces of recording information in one print request are analyzed (Act 313). If all the pieces of recording information are analyzed (Yes in Act 313), the CPU 2011 ends the conversion into recording data. If not all the pieces of recording information are analyzed (No in Act 313), the CPU 2011 returns to Act 305 and continues the processing. Thereafter, the CPU 2011 outputs the recording data stored in the memory 2012 to the image-forming-unit controller 205 in the same manner as in the first embodiment.

In Acts 310 and 312, the CPU 2011 corrects the density of the image data of the side having the smaller average printing ratio in the overlapping portion to be reduced. However, the CPU 2011 may correct the density of the image data of the side having the larger average printing ratio to be reduced. In this case, the ink jet recording apparatus 1 can save inks necessary for forming images. In Act 309, the CPU 2011 compares the densities of the image data on the basis of the average printing ratios. However, the CPU 2011 may compare the densities of the image data on the basis of maximum densities, ink amounts, or whether printing is monochrome printing or color printing.

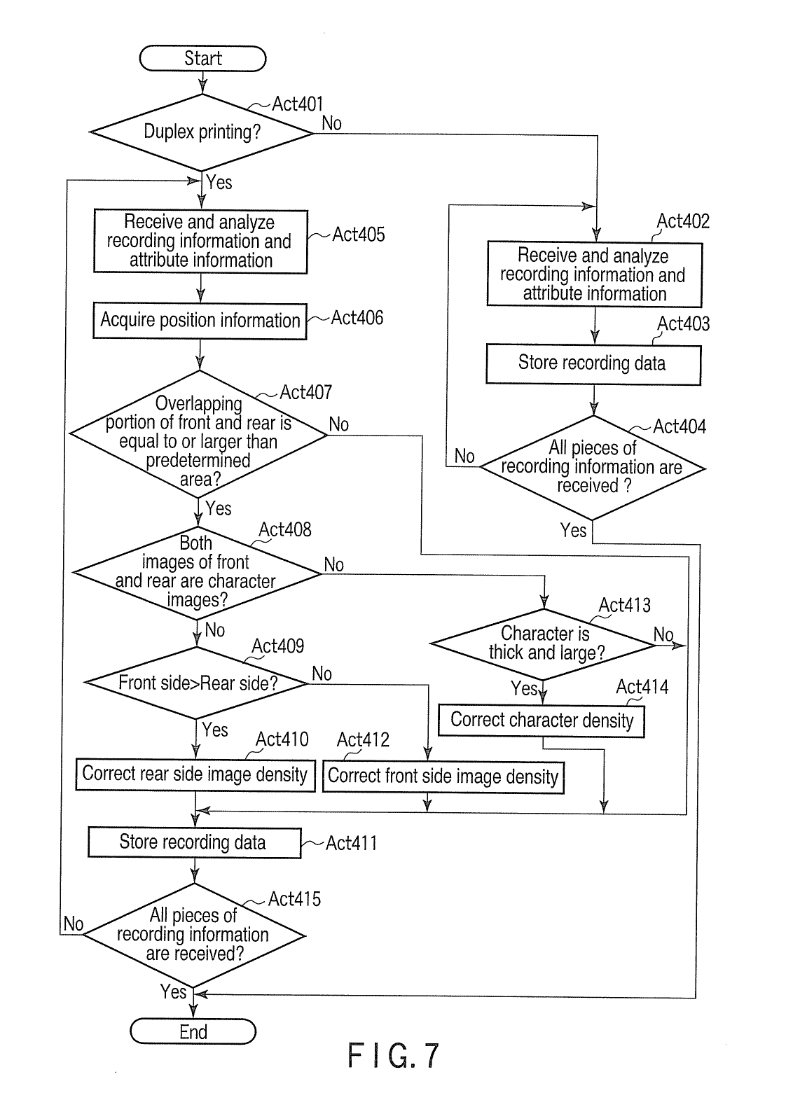

FIG. 7 is a flowchart for explaining processing for creating recording data according to a fourth embodiment. The fourth embodiment is an example in which print density is corrected according to position information of image data printed on the front side of a sheet and image data printed on the rear side of the sheet and whether the image data is character data. First, the CPU 2011 determines whether an instruction for the duplex printing is included in recording information requested to be printed (Act 401). If the duplex printing is not instructed (No in Act 401), the CPU 2011 receives and analyzes recording information and attribute information concerning the simplex printing input in the host computer 5 (Act 402). The CPU 2011 converts image data of one side acquired from the recording information into recording data and temporarily stores the recording data in the memory 2012 (Act 403). The CPU 2011 determines whether all pieces of recording information in one print request are analyzed (Act 404). If all the pieces of recording information are analyzed (Yes in Act 404), the CPU 2011 ends the conversion into recording data. If not all the pieces of recording information are analyzed (No in Act 404), the CPU 2011 returns to Act 402 and continues the processing.

If the duplex printing is instructed (Yes in Act 401), the CPU 2011 receives and analyzes recording information and attribute information concerning the duplex printing input in the host computer 5 (Act 405). The CPU 2011 acquires position information of image data of the front side and the rear side of a sheet from the attribute information of the respective sides (Act 406). The CPU 2011 determines whether, when images are formed on the front side and the rear side of the sheet in the ink jet recording apparatus 1, an overlapping portion of the front and the rear is equal to or larger than a predetermined area (Act 407). If the overlapping portion is equal to or larger than the predetermined area (Yes in Act 407), the CPU 2011 determines whether both image data in the overlapping portion of the front side and the rear side are character data (Act 408). If both the image data in the overlapping portion are not character data (No in Act 408), the CPU 2011 compares, concerning image data size in the overlapping portion, image data size of the rear side and image data size of the front side and determines whether the former is smaller than the latter (Act 409). If the image data of the rear side is smaller than the image data of the front side (Yes in Act 409), the CPU 2011 corrects (reduces) the density of the image data of the rear side (Act 410). After correcting the image data of the rear side, the CPU 2011 converts the image data into recording data and temporarily stores the recording data in the memory 2012 (Act 411).

If the image data of the front side is smaller than the image data of the rear side (No in Act 409), the CPU 2011 corrects (reduces) the density of the image data of the front side (Act 412). After correcting the image data of the front side, the CPU 2011 converts the image data into recording data and temporarily stores the recording data in the memory 2012 (Act 415). If both the image data in the overlapping portion are character data (Yes in Act 408), the CPU 2011 compares thicknesses and sizes of characters in the character data in the overlapping portion of the front side and the rear side (Act 413). The CPU 2011 corrects (reduces) the density of the image data of the side having the larger thickness and size of the characters (Act 414). On the other hand, the CPU 2011 does not correct the density of the image data of the side having the smaller thickness and size of the character (No in Act 413). After correcting the image data of one side, the CPU 2011 converts the image data into recording data and temporarily stores the recording data in the memory 2012 (Act 415). If the overlapping portion is not equal to or larger than the predetermined area (No in Act 407), the CPU 2011 converts the image data of both the sides into recording data without correcting the image data and temporarily stores the recording data in the memory 2012 (Act 415).

Thereafter, the CPU 2011 determines whether all pieces of recording information in one print request are analyzed (Act 415). If all the pieces of recording information are analyzed (Yes in Act 415), the CPU 2011 ends the conversion into recording data. If not all the pieces of recording information are analyzed (No in Act 415), the CPU 2011 returns to Act 405 and continues the processing. Thereafter, the CPU 2011 outputs the recording data stored in the memory 2012 to the image-forming-unit controller 205 in the same manner as in the first embodiment.

In Acts 410 and 412, the CPU 2011 corrects the density of the image data of the side having the smaller image data size in the overlapping portion to be reduced. However, the CPU 2011 may correct the density of the image data of the side having the larger image data size to be reduced. In this case, the ink jet recording apparatus 1 can save inks necessary for forming images. In Act 413, the CPU 2011 compares the thicknesses and the sizes of the characters of the front side and the rear side. However, the CPU 2011 may compare densities or printing ratios of color characters of the front side and the rear side. As a result of comparing the front side and the rear side, first, the CPU 2011 may print the side on which the density is corrected to be reduced.

In the embodiments, if the overlapping portion in the duplex printing is equal to or larger than the predetermined area, the density of the image data of one of the surfaces is selectively reduced. However, the density of the image data of both the sides may be reduced to be lower than that during the simplex printing and the density of the image data of one of the sides may be further selectively reduced. In the embodiments, if the overlapping portion in the duplex printing is equal to or larger than the predetermined area, the density of the image data of both the sides may be reduced. In the embodiments, even if conditions (image data sizes, average printing ratios, etc.) are the same on the front side and the rear side in the overlapping portion in the duplex printing, the image data of arbitrary at least one side only has to be corrected.

The processing for creating recording data shown in FIGS. 3, 5, 6, and 7 in the embodiments may be performed by a CPU of the host computer 5. In this case, the host computer 5 is equivalent to an image processing apparatus. According to the embodiments, it is possible to prevent image quality deterioration (e.g., a blur of an image due to show-through) in the duplex printing by the ink jet recording apparatus 1.

In the disclosed embodiments, the processing can be accomplished by a computer-executable program, and this program can be realized in a computer-readable memory device. In the embodiments, the memory device, such as a magnetic disk, a flexible disk, a hard disk, an optical disk (CD-ROM, CD-R, DVD, and so on), an optical magnetic disk (MD and so on) can be used to store instructions for causing a processor or a computer to perform the processes described above.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing apparatus comprising:
a detecting unit configured to detect an overlapping portion of a first image printed on a first side of a sheet and a second image printed on a second side opposite to the first side;
a determining unit configured to determine whether the overlapping portion of the first image and the second image detected by the detecting unit is equal to or larger than a predetermined area; and
a correcting unit configured to correct, if the overlapping portion is equal to or larger than the predetermined area, density of one of the first image and the second image.

2. The apparatus of claim 1, wherein the detecting unit detects the overlapping portion based on position information of the first image with respect to the first side and position information of the second image with respect to the second side.

3. The apparatus of claim 1, wherein the correcting unit corrects the density to be reduced.

4. The apparatus of claim 3, wherein the correcting unit subjects pixels to thinning-out processing.

5. The apparatus of claim 1, wherein the correcting unit corrects the density based on data size of the first image and data size of the second image in the overlapping portion.

6. The apparatus of claim 1, wherein the correcting unit corrects the density based on whether the first image and the second image in the overlapping portion are texts.

7. The apparatus of claim 6, wherein the correcting unit corrects one of the first image and the second image without text in the overlapping portion.

8. The apparatus of claim 1, wherein the correcting unit corrects the density based on an averaging printing ratio of the first image and an average printing ratio of the second image in the overlapping portion.

9. The apparatus of claim 1, wherein the correcting unit corrects, if the first image and the second image in the overlapping portion are texts, the density based on a characteristic of the texts.

10. The apparatus of claim 1, wherein the correcting unit changes a correction ratio of the density.

11. The apparatus of claim 1, further comprising an ink jet recording head configured to print the first image and the second image on the sheet.

12. A computer-readable medium having stored therein a computer program executed by a computer, the computer program causing the computer to execute:
a detecting function for detecting an overlapping portion of a first image printed on a first side of a sheet and a second image printed on a second side opposite to the first side;
a determining function for determining whether the overlapping portion of the first image and the second image detected by the detecting function is equal to or larger than a predetermined area; and
a correcting function for correcting, if the overlapping portion is equal to or larger than the predetermined area, density of one of the first image and the second image.

13. The medium of claim 12, wherein the detecting function detects the overlapping portion based on position information of the first image with respect to the first side and position information of the second image with respect to the second side.

14. The medium of claim 12, wherein the correcting function corrects the density based on data size of the first image and data size of the second image in the overlapping portion.

15. An image processing method comprising:
detecting an overlapping portion of a first image printed on a first side of a sheet and a second image printed on a second side opposite to the first side;
determining whether the detected overlapping portion of the first image and the second image is equal to or larger than a predetermined area; and
correcting, if the overlapping portion is equal to or larger than the predetermined area, density of one of the first image and the second image.

16. The method of claim 15, further comprising detecting the overlapping portion based on position information of the first image with respect to the first side and position information of the second image with respect to the second side.

17. The method of claim 15, further comprising correcting the density based on data size of the first image and data size of the second image in the overlapping portion.

18. The method of claim 15, further comprising correcting the density based on whether the first image and the second image in the overlapping portion are texts.

19. The method of claim 15, further comprising correcting the density based on an averaging printing ratio of the first image and an average printing ratio of the second image in the overlapping portion.

20. The method of claim 15, further comprising printing the first image and the second image on the sheet.
